(19) United States
(12) Patent Application Publication
(10) Pub. No.: US 2017/0034455 A1
(43) Pub. Date: Feb. 2, 2017

(54) DETECTOR UNIT, OPTICAL SYSTEM AND THERMAL CAMERA ASSEMBLY

(71) Applicant: FLIR Systems AB, Täby (SE)

(72) Inventor: Fredrik Mattinson, Täby (SE)

(21) Appl. No.: 15/213,302

(22) Filed: Jul. 18, 2016

Related U.S. Application Data
(60) Provisional application No. 62/197,491, filed on Jul. 27, 2015.

(51) Int. Cl. H04N 5/33; G02B 27/00; H04N 5/225

(52) U.S. Cl. CPC H04N 5/33; H04N 5/2254; G02B 27/0006; G02B 27/0025

(57) ABSTRACT

Devices and methods herein, in accordance with embodiments, provide a detector unit for an infrared (IR) imaging device comprising a focal plane array (FPA) of IR detectors configured to detect IR radiation intensity, and a detector unit lens configured to optically direct IR radiation onto the FPA and to protect the FPA from contamination. The detector unit lens and the FPA are integrated to form a detector unit that encapsulates the FPA, and the detector unit lens is configured to optically function as a common lens element for a plurality of different types of lens assemblies of the IR imaging device. Other embodiments herein provide for an IR imaging system, and for methods of manufacturing a detector unit.

### CROSS-REFERENCE TO RELATED APPLICATIONS

This application claims the benefit of and priority to U.S. Provisional Patent Application No. 62/197,491 filed Jul. 27, 2015 and entitled “DETECTOR UNIT, OPTICAL SYSTEM AND THERMAL CAMERA ASSEMBLY”, which is incorporated herein by reference in its entirety

### TECHNICAL FIELD

Embodiments herein relates generally to the field of infrared imaging systems and methods, and in particular, to a detector unit for capturing images of infrared radiation. Other embodiments herein relate to an infrared imaging system, and to methods for manufacturing a detector unit.

### BACKGROUND

Thermal, or infrared (IR), images of scenes are often useful for monitoring, inspection and/or maintenance purposes, e.g. for surveillance. Typically, a thermal imaging device with a thermal imaging system, for example in the form of an infrared IR camera, is provided to capture infrared (IR) image data values, representing infrared radiation from an observed real world scene.

Depending on the use case scenario, varying Field of View (FOV) is desired, e.g. by applying interchangeable optical lens assemblies with multiple lens designs. The number of lenses and the properties of each lens may be selected according to various properties and will result in a total lens design where the different lenses have combined optical characteristics, thus resulting in varying properties of the lenses present, e.g. size, first surface radius and second surface radius.

There is a need to address the problems in known thermal imaging devices and cameras relating to the complexity of the lens arrangement.

### SUMMARY

Various techniques and embodiments of a detector unit and an optical system, are provided. Further, embodiments of a thermal camera assembly and a thermal imaging device are provided.

Various embodiments of the present disclosure may beneficially solve or at least to minimize the problems mentioned above. For example, this may be achieved by a detector unit for capturing infrared radiation implemented according to various embodiments of the disclosure.

The detector unit comprises an infrared detector integrated with a detector unit lens, and is configured such that the detector unit lens refracts radiation onto the infrared detector.

The radiation may be refracted onto the detector without any intermediate material present in the radiation path. The detector unit may be configured to optically cooperate with the optical lens assembly such that the infrared radiation is captured by the detector.

In some embodiments, the detector unit lens may be configured to reduce optical aberrations for a plurality of different optical lens assemblies.

In some embodiments, the detector unit may further comprise a baffle arranged to reduce disturbance light.

In some embodiments, the baffle may be configured between the detector unit lens and the infrared detector.

In some embodiments, the detector unit may further comprise a sealing arrangement. The sealing arrangement, the infrared detector and the detector unit lens may define a space sealed from the surrounding environment.

In some embodiments, the detector unit lens may be arranged to reduce different optical effects for different fields of view. Such optical effects may for example be field curvature, astigmatism, coma and spherical aberrations.

In some embodiments, the detector unit lens may be a germanium lens or a chalcogenide lens.

In some embodiments, the detector unit may comprise one or more additional detector unit lens.

In some embodiments, the baffle may be configured between the detector unit lens and the one or more additional detector unit lens.

Other embodiments herein relate to an optical system for capturing images of infrared radiation.

The optical system for capturing images of infrared radiation comprises an optical lens assembly arranged to receive infrared radiation and a detector unit comprising an infrared detector integrated with a detector unit lens. The detector unit is configured such that the detector unit lens refracts the received infrared radiation onto the infrared detector.

In some embodiments, the detector unit and the optical lens assembly may be optically configured such that the infrared radiation is focused onto the detector for capturing images of the infrared radiation.

In some embodiments, the detector unit and the optical lens assembly may be moveable in relation to each other such that the infrared radiation can be focused onto the detector for capturing images of the infrared radiation.

In some embodiments, the optical lens assembly comprises one or more optical elements, and the optical lens assembly may be configured to optically cooperate with (e.g., optically cooperate or correspond with) said detector unit.

In some embodiments, the detector unit may be configured to fit with (e.g., engage or mate with) optical lens assemblies of different types.

In some embodiments, the detector unit may be configured to optically cooperate to the optical lens assembly such that the infrared radiation is focused onto the detector for capturing images of the infrared radiation.

In some embodiments, the detector unit may be configured to fit with a plurality of optical lens assemblies, each with different optical characteristics.

In some embodiments, the detector unit lens may be arranged in the vicinity of the detector. The detector unit lens may be arranged to protect the detector from contaminations from the environment.

In some embodiments, the F-number may remain constant when focusing the optical system.

In some embodiments, the detector unit lens and the optical lens assembly may form an optical system with a Field of View (FOV) selected from 7, 20, 30, 38, 45, 55 or 60 degrees.

Other embodiments herein relate to a thermal camera assembly comprising a housing, an optical lens assembly arranged to receive infrared radiation from an observed real-world scene, an infrared detector integrated with a detector unit lens and being configured such that the detector unit lens refracts the received infrared radiation onto the infrared detector, and an IR image generation unit arranged to generate an infrared image based on the infrared radiation refracted onto the infrared detector.

In some embodiments of the thermal camera assembly, the detector unit lens may be configured to reduce optical aberrations for a plurality of different optical lens assemblies.

In some embodiments of the thermal camera assembly, the detector unit may further comprise a baffle arranged between the detector and the detector unit lens to reduce stray light.

In some embodiments of the thermal camera assembly, the detector unit may further comprise a sealing arrangement, and the sealing arrangement, the infrared detector and the detector unit lens may define a space sealed from the surrounding environment.

In some embodiments of the thermal camera assembly, the detector unit lens may be arranged to reduce different optical effects for different fields of view.

In some embodiments of the thermal camera assembly, the detector unit lens may be a germanium lens or a chalcogenide lens.

In some embodiments of the thermal camera assembly, the detector unit may comprise a further detector unit lens.

In some embodiments of the thermal camera assembly, the detector unit lens may be arranged in the vicinity to the detector, and may be arranged to protect the detector from contaminations from the environment.

In some embodiments of the thermal camera assembly, the detector unit and the optical lens assembly may be optically configured such that the infrared radiation is focused onto the detector for capturing images of the infrared radiation.

In some embodiments of the thermal camera assembly, the detector unit and the optical lens assembly may be moveable in relation to each other such that the infrared radiation can be focused onto the detector for capturing images of the infrared radiation.

In some embodiments of the thermal camera assembly, the optical lens assembly may comprise one or more optical elements, and the optical lens assembly may be configured to optically cooperate with (e.g., optically cooperate or correspond with) the detector unit.

In some embodiments of the thermal camera assembly, the detector unit may be configured to fit with (e.g., engage or mate with) a plurality of optical lens assemblies, each with different optical characteristics.

In some embodiments of the thermal camera assembly, a FOV may be selected from 7, 20, 30, 38, 45, 55 or 60 degrees.

The scope of the disclosure is defined by the claims, which are incorporated into this section by reference. A more complete understanding of embodiments herein will be afforded to those skilled in the art, as well as a realization of additional advantages thereof, by a consideration of the following detailed description of embodiments. Reference will be made to the appended sheets of drawings that will first be described briefly.

### BRIEF DESCRIPTION OF THE DRAWINGS

FIG. 1 is a block diagram illustrating an optical system comprising a detector unit in accordance with embodiments herein.

FIG. 2 is a schematic view of an optical system according to embodiments herein.

FIG. 3 illustrates an example of an optical system in accordance with embodiments herein.

FIG. 4 illustrates another example of an optical system in accordance with embodiments herein.

FIG. 5 is a block diagram illustrating an example of a thermal camera assembly in accordance with embodiments herein.

Embodiments of the present disclosure and their advantages are best understood by referring to the detailed description that follows. It should be appreciated that like reference numerals are used to identify like elements illustrated in the figures.

### DETAILED DESCRIPTION

In order to better appreciate embodiments herein, a discussion regarding prior art and problems related thereto will be provided in the following.

IR detectors are sensitive to dust and contamination that may generate recurring defects in captured IR images. Some conventional IR detector units therefore include a detector window to protect the IR detector. For example, a conventional IR detector unit may be provided in a wafer level package (WLP) that has a protective window (e.g., a silicon window) in a close proximity (e.g., around 0.1 mm) of the focal plane array (FPA) of IR detector to encapsulate the FPA. However, because such a conventional protective window is located close to the FPA (e.g., typically within the depth-of-field of the focus plane of the FPA), dust, damage, or other contamination on the FPA still creates large defects in the captured IR images. Thus, to avoid damages and contamination to the protective window encapsulating the FPA, conventional encapsulated detector units must still be handled in a cleanroom environment, which increases cost and complexity of producing detector units and IR imaging systems that incorporate detector units.

While the problem of damages and contamination to the protective window causing large image defects may be mitigated by providing an extra window or relocating the protective window further from the FPA, a conventional protective window still creates optical problems. This is because the window creates spherical aberrations in a converging field and transmission loss when the IR radiation passes through the window, without adding any advantages to the specific optical system design. Furthermore, such optical problems may be exacerbated if an extra window is provided and/or the window is further from the FPA.

Embodiments herein will now be described in detail. In particular, embodiments herein relate to a detector unit, an optical system, a thermal imaging device and to methods therein, and to computer program products for capturing images (e.g., in the form IR image data, pixel data, or other analog or digital signal or data representing IR radiation intensity) of infrared radiation from an observed scene (e.g., infrared radiation emitted, transmitted, or reflected from an observed scene).

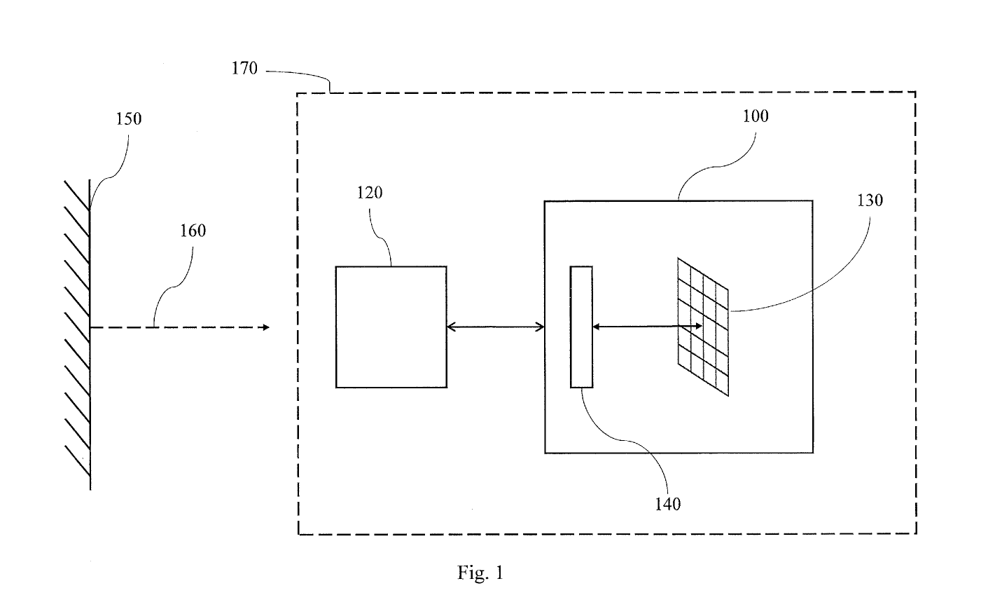

FIG. 1 shows an example of an optical system 170 comprising a detector unit 100 for capturing images of infrared radiation. The detector unit 100 may for example form part of an IR imaging system or an IR camera. The detector unit 100 is configured to fit with (e.g., mechanically mate or engage with) an optical lens assembly 120 arranged to receive infrared radiation 160 from an observed scene 150. The detector unit 100 comprises an infrared detector 130 integrated with a detector unit lens 140. The detector unit lens 140 may be fixed or moveable in relation to the infrared detector 130. The detector unit lens 140 is arranged to refract the received infrared radiation towards the infrared detector 130. The detector unit 100 is configured such that the detector unit lens 140 refracts radiation onto the detector 130. In some embodiments, the radiation may be refracted onto the infrared detector 130 without any intermediate material present in the radiation path. In some embodiments, the detector unit may be implemented as a mechanical radiometric module including a detector lens (e.g., detector lens 140) that is to be used for optical lens assemblies (e.g., various types of optical lens assemblies 120). Different types of optical lens assemblies 120 may have different predefined field of view steps, for example 7°, 20°, 30°, 38°, 45°, 55° and 60°. The detector unit lens 140 and the optical lens assembly 120 may thus form an optical system with a FOV selected from 7, 20, 30, 38, 45, 55 or 60 degrees. The infrared detector 130 may be encapsulated and the different types of optical lens assemblies 120 may be interchangeable.

The optical system 170 may be focused by moving the infrared detector 130 in relation to the detector unit lens 140, by moving the detector unit lens 140 or by moving the infrared detector 130, or by moving the lens assembly 120 in relation to the detector unit 100. It is to be noted that any lens comprised in the optical system 170 may be moveable. Thus, in some embodiments, the optical system 170 may be designed as a focusing system with constant F-number (also known as F#, focal ratio, F-ratio, F-stop, or relative aperture). Such a system may be focused by moving the lenses in front of the aperture stop, or by moving the infrared detector 130 or the detector unit lens 140 as described above. The F-number may remain constant when focusing such an optical system. The optical lens assembly 120 may comprise a further lens, and may be an interchangeable optical lens assembly.

The infrared detector 130 may be of any suitable type, and may for example be a wafer level packaged FPA having 640×480 pixels in a pixel pitch of 12 μm. A design for a WLP FPA of 1024×768 pixels in a 17 μm pixel pitch or other resolutions and pixel pitches may also be achievable in other examples. The detector unit 100 may be configured to fit with the optical lens assembly 120 such that the infrared radiation 160 is directed onto (e.g., focused or refracted onto) the infrared detector 130 for capturing images of the infrared radiation 160.

The distance between the detector unit lens 140 and the infrared detector 130 is much larger than the distance between the infrared detector and the detector window in prior art solutions. Thus, any dust contaminated on the detector unit lens will give rise to a much smaller defect in a captured image compared with dust contaminated on the surface of the detector window in the prior art solutions.

Furthermore, in various embodiments, the detector unit lens 140 may be configured to cooperate, correspond, or otherwise fit optically with a plurality of different types of optical lens assemblies 120. In this regard, the detector unit lens 140 may be configured so that it can serve as a lens element (e.g., a rear element) that is common to different types of optical lens assemblies 120 having one or more other lens elements, where the detector unit lens 140 as a common lens element can optically functions together with the one or more other lens elements of any of the optical lens assemblies 120 to direct the received infrared radiation onto the infrared detector 130. For example, the detector unit lens 140, being closest to the infrared detector, may perform a function of a rear lens element that mainly reduces field curvature aberration for a plurality of different optical lens assemblies 120. By providing a detector unit 100 with one detector unit lens 140 that can be commonly used with a plurality of different optical lens assemblies 120, production and assembly of optical lens assemblies 120 and infrared imaging systems may be simplified since fewer components are used. This in turn can beneficially reduce the cost of goods sold (COGS) for optical lens assemblies 120 and further, the COGS for overall infrared imaging systems. In one embodiment, the common detector unit lens 140 may be made of silicon, the same material as the detector window, and may be attached by the detector manufacturer when manufacturing the detector unit. In some embodiments, the detector unit lens 140 may be made of other suitable material enabling the optical design to work.

A detector unit (e.g., detector unit 100) with one single detector unit lens (e.g., detector unit lens 140) may be used with a plurality of fields of views, any and all of which can be mapped to the detector 130. For example, optical lens assemblies 120 respectively with 7°, 20°, 30°, 38°, 45°, 55° and 60° horizontal FOVs may be provided for convenient swapping, switching, or exchanging by an end user out in the field as desired for particular applications. Such different types of optical lens assemblies 120 with different FOVs may also be denoted herein as FOV7, FOV 25, FOV 30, FOV 38, FOV 55 and FOV60, respectively. Manufacturing of one type of detector unit lens that can optically function together with different optical lens assemblies (e.g., FOV 7, 25, 30, 38, 55 and 60) may enable a higher production volume, since an autoloader or other automation tools for high volume lens manufacturing can be utilized. Thus, for example, optical lens assemblies, such as FOV 7 for example, that were conventionally expensive to manufacture may now beneficially be manufactured at a lower cost.

Moreover, since the common detector unit lens 140 is robust against image quality problems due to contamination and also protects the infrared detector 130 as further discussed herein, the user can safely and conveniently swap different optical lens assemblies 120 as desired in the field without worrying about dust or damage causing large defects in captured images. In this regard, for example, a set of different optical lens assemblies 120 with different FOVs (e.g., a set of four or more types of optical lens assemblies 120 providing four or more different FOVs) can advantageously replace a zoom lens system that is more complex, more expensive, heavier, and cumbersome for handheld use compared with a fixed FOV lens assembly.

In some embodiments, the detector unit 100 may further comprise a further detector unit lens (not shown in FIG. 1). Thus, it is possible to provide the detector unit with two common lenses (e.g., functioning as two rearmost lens elements) for a plurality of lens assemblies instead of one common lens.

In addition to these various benefits due to a simpler design, ease of handling during manufacturing (e.g., relaxed requirement for a cleanroom environment) and in the field, and increased opportunities for automation, the techniques disclosed herein provides further reduction in cost and improvement in optical performance of the optical system 170 since the optical analysis and design process for can be optimized with respect to the one common detector unit lens 140 and need not be repeated for different types of optical lens assemblies 120.

In particular, for example, an analysis, design, and manufacturing process that can reduce the influence of disturbance radiation for the detector unit 100 can be performed, in accordance with embodiments of the disclosure. Simulations and measurements show that disturbance radiation may have a crucial influence on image quality, as well as on radiometric measurement. Simulations and measurements performed in connection with the present disclosure reveal that 99% of unwanted reflection may come from the image plane. With an 80% fill factor, this gives 80% absorption, and 20% disturbance radiation. Of this 20%, it may be estimated that 10% of the disturbance radiation is specular and reflected into the lens, and that 10% is diffuse disturbance radiation. Based on the simulation and measurement of disturbance radiation, the detector unit 100 may be designed (e.g., to include a baffle between the detector unit lens 140 and the infrared detector 130, as further described herein) to optimize optical performance. Other optical properties may be analyzed to optimize the optical performance of the detector unit 100 (e.g., by determining the diameter, position, and optical functionalities of the detector unit lens 140) with respect to various different types of optical lens assemblies 120 that may be used together.

Such an analysis, design, and manufacturing process according to various embodiments may produce a detector unit 100 and various optical lens assemblies 120 having desirable optical properties. In some examples, the process may be applied to a fixed-focus system using a FPA of 640×480 pixels in a 17 μm pixel pitch. In some examples, the process may be applied to lenses suitable for long-wave infrared (LWIR) and lenses made of Germanium (Ge). The process may also be applied to lenses that may be athermalized and/or made of other lens materials in other examples. Further, a system produced by the process may be athermalized by switching the lens material or/and by having a mechanic thermalizing.

The different optical lens assemblies 120 that can be produced according to various embodiments may include, for example, a FOV 7 with F-number of 1.3, a FOV 20 with F-number of 1.2, a FOV 38 with a F-number of 0.9, and a FOV 60 with a F-number of 1.2, all with excellent image quality at far focus. As may be appreciated, a very low F-number is achieved for FOV 38 and FOV 45 It is contemplated that even lower F-numbers may be achievable, for example lowered towards F#1.0.

In another aspect, the detector unit 100 according to some embodiments may further comprise a sealing arrangement configured to be fit to the infrared detector 130 and/or to the detector unit lens 140. In such embodiments, the sealing arrangement, the infrared detector 130, and the detector unit lens 140 define a space sealed from the surrounding environment. As discussed above, a conventional infrared detector unit for infrared imaging systems needs to be handled in a clean room during assembly to avoid dust and contamination being trapped within the infrared imaging system and causing image quality degradation. The detector unit 100 having a sealing arrangement according to such embodiments allows the detector unit 100 and the infrared imaging system to be handled in a less restrictive environment. Time will be saved, since less care is needed when handling a detector unit provided with a sealing arrangement and no clean room will be needed. This is an important benefit with using such a sealing arrangement, which, for example, encapsulates the infrared detector 130 (e.g., a FPA) by the detector unit 100 with the common detector unit lens 140 that can be used together with a plurality of different optical lens assemblies 120. To handle such a sealed, encapsulated detector unit in production is easy and efficient. Due to the simplified and more efficient handling, COGS and performance are improved. Further, assembling will be simplified, since the detector unit 100 need not be designed differently for different optical lens assemblies (e.g., to work with any of FOV 7, 25, 30, 38, 55 and 60) but instead may be designed mechanically with the same housing.

The detector unit lens 140 may be arranged in the vicinity of the infrared detector 130, and may be arranged to protect the infrared detector 130 from contaminations from the environment. The detector unit lens 140 may further be arranged to reduce different optical effects for different field of view. For example, in some embodiments, the detector unit lens 140 may include a field lens. A field lens is a field flattener used to reduce the field curvature and to flatten the field. Lenses having a low F-number (e.g., fast lenses) and/or a wide FOVs typically utilize a field lens as a lens element. The detector unit lens 140 providing the function of a field lens according to embodiments of the disclosure is designed such that it will enable clear image capturing for different FOV steps.

Generally, a lens manufacturer looks to provide three to six different lens assemblies with differing FOVs, and thus differing focal length, for an infrared detector (e.g., FPA) with a given size and resolution. In some embodiments of the disclosure, the detector unit lens 140 may be suitable for different lens designs, for example FOV 7, FOV 20, FOV 30, FOV 38, FOV 45, FOV 55 and FOV 60. The detector unit lens 140 is the lens closest (e.g., performing the function of the rear lens element of a lens assembly) to the infrared detector 130 mainly reducing field curvature, and may have the same distance to the detector plane for all designs. In some embodiments, the infrared detector 130 may comprise a plurality of bolometers configured to detect LWIR radiation.

As a specific implementation example according to embodiments of the disclosure, the detector unit lens 140 may have a diameter of 22 mm and the distance between the detector unit lens 140 and the infrared detector 130 may be 8 mm. In another implementation example, the diameter of the detector unit lens may be 19.5 mm and the distance from the detector unit lens to the infrared detector may be 8.48 mm. As discussed above, the lens diameter, the position, and/or other optical design parameters for the detector unit lens 140 and the detector unit 100 may be determined by analyzing and optimizing the optical performance with respect to various different types of optical lens assemblies 120.

The detector unit lens may be a germanium lens or a chalcogenide lens, or as an alternative a silicon lens. In the LWIR spectrum (e.g., in the waveband of 8-14 μm), lens material as Germanium (Ge), Zinc Sulfide (ZnS), or Zinc Selenide (ZnSe) is used, and if thin enough as detector window, Silicon (Si)(there are also different variants of Si) may be used. Chalcogenide is very useful for production in large volumes since they are molded, and also suitable for IR cameras to be used with fixed focus in a wide ambient temperature range (e.g., from −40° C. up to +85° C.). Thus, chalcogenide may be suitable for producing a low cost thermal camera.

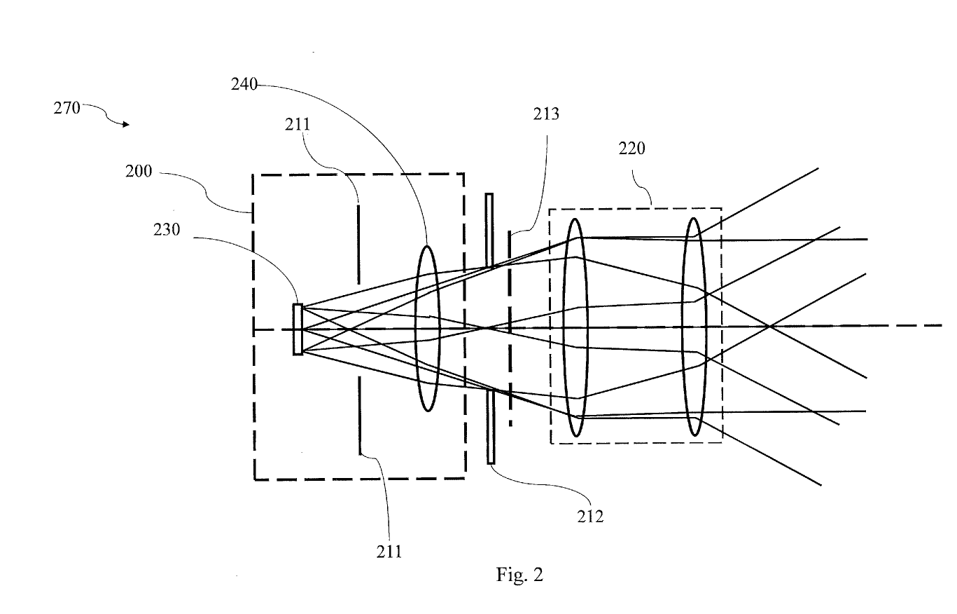

FIG. 2 shows an example of an optical system 270 in accordance with an embodiment of the disclosure. The example optical system 270 comprises a lens assembly 220 with optical elements, in the example shown as two lenses, which may for example be germanium lenses, and one detector unit 200. Further, a shutter 213 is shown. An aperture stop 212 is located between a detector unit lens 240 and the rearmost lens element of the lens assembly 220 in the optical system 270. This arrangement of the aperture stop 212 can permit the front lens diameter (e.g., the diameters of the one or more lens elements in the lens assembly 220) of the optical system 270 to be minimized.

The detector unit 200 may comprise a baffle, or a plurality of baffles 211. The baffles 211 are in the shown example arranged between the detector unit lens 240 and the infrared detector 230. The baffles 211 may be designed to be applied to or work with different types of lens assemblies 220. The baffles 211 are provided in order to limit problems related to disturbance radiation, such as stray light radiation, reflections background radiation or any other disturbance radiation.

As discussed briefly above, such an arrangement of the baffles 211 between the detector unit lens 240 and the infrared detector 230 allows the baffles 211 to be analyzed and designed (e.g., determine the shape, size, number and/or location of the baffles 211) without having to repeat the analysis and design for each of the different types of lens assemblies to be used, since the detector unit lens 240 may function as a common rear lens element for the different types of lens assemblies to be used. In general, the largest contributor to disturbance radiation in an IR system is the reflection of the incoming infrared radiation caused by the infrared detector and the lens closest to the infrared detector. For example, diffuse and specular stray infrared radiation may be about 20% of the incoming infrared radiation (assuming about 80% fill factor for the infrared detector). In embodiments of the disclosure, since the detector unit lens 240, which is the closest lens to the infrared detector 230, may be provided together with the infrared detector 230 in the detector unit 200, the analysis of stray infrared radiation and the analysis and design of the baffles 211 to reduce the stray infrared radiation need to be performed only once with respect to the detector unit 200 and not repeated for different optical lens assemblies 220 having different rear lens elements.

The infrared detector 230 may be of any suitable type, and may for example be a FPA having 640×480 pixels in a pixel pitch of 17 μm. The example optical system 270 may represent a system suitable to provide a horizontal FOV of 7 degrees and a good optical performance with an F-number of 1.3.

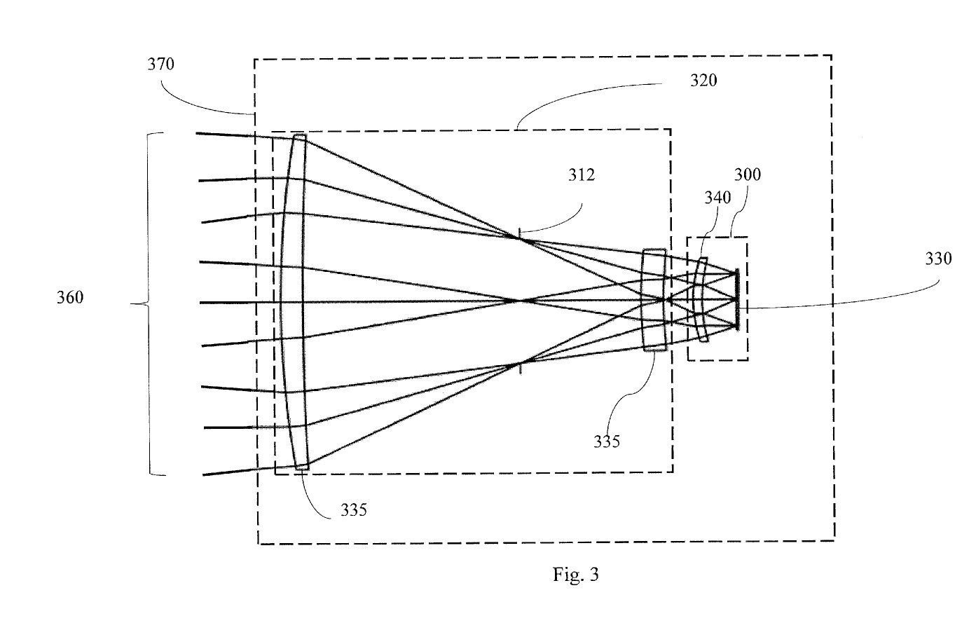

FIG. 3 illustrates another example of an optical system 370 in accordance with an embodiment of the disclosure. The optical system 370 comprises a lens assembly 320 comprising optical elements 335, exemplified as two lenses, which also may be of Germaniun, and one detector unit 300. The optical lens assembly 320 is arranged to receive infrared radiation 360 from an observed scene. The plurality of optical elements 335 are designed to interact (e.g., optically function together) to direct (e.g., refract) the infrared radiation 360. Infrared radiation beams of the infrared radiation 360 are refracted in a plurality of lenses (e.g., including the optical elements 335 of the optical lens assembly 320 and a detector unit lens 340) in a predetermined way towards an infrared detector 330. The infrared detector 330 may be provided with a detector window (not shown). The infrared radiation beams are travelling from the lenses towards the detector unit 300 and are refracted towards the infrared detector 330. An aperture stop 312 is in the illustrated example located between the optical elements 335.

In the example optical system 370 of FIG. 3, the infrared detector 330 comprises an infrared detector FPA having 640×480 pixels with a pixel pitch of 17 μm and a thin silicon window encapsulating the FPA at a close proximity to the FPA (e.g., 0.1 mm from the FPA). The common detector unit lens 340 in the example optical system 370 may be at a distance of about 8 mm from the thin silicon window. The example optical system 370 may represent a system suitable to provide a horizontal FOV 7 degrees and a good optical performance with an F-number of 1.3.

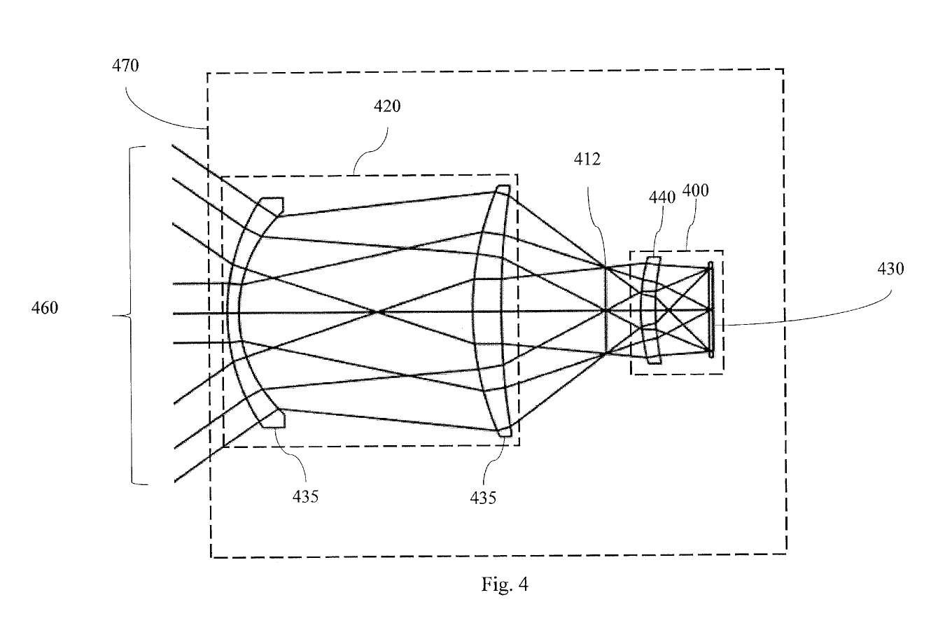

FIG. 4 illustrates another example of an optical system 470 for capturing images of infrared radiation 460 from an observed scene, in accordance with an embodiment of the disclosure. In the example optical system 470, an optical lens assembly 420 is arranged to receive the infrared radiation 460. The optical lens assembly 420 is in the illustrated example provided with two optical elements 435, in the figure shown as two lenses of different design (e.g., as different lens elements to provide respective optical functionalities). The lenses may be two Germanium lenses. The optical elements 435 may have different size and curvature, and are designed to interact (e.g., optically function together) to direct (e.g., refract) the received infrared radiation 460. The optical elements 435 may be moveable, and the optical system may be focused by moving any of the optical elements 435 in relation to each other, or by moving the optical lens assembly 420 in relation to a detector unit 400. The infrared radiation beams are in the two optical elements 435 refracted in a predetermined way towards the infrared detector unit 400. The detector unit 400 may for example comprise an infrared detector 430 having 640×480 pixels with a pixel pitch of 17 μm with a thin silicon window encapsulating the infrared detector 430 at a close proximity (e.g., 0.1 mm) and a detector unit lens 440 at a distance of about 8 mm from the thin silicon window. An aperture stop 412 is arranged between the optical lens assembly 420 and the detector unit 400. It is to be noted that the optical design of the optical elements 435 are adapted to optically cooperate with (e.g., optically cooperate or correspond with) the detector unit lens 440 such that the infrared radiation 460 is refracted towards the infrared detector 430 when refracted in the optical elements 435 and in the detector unit lens 440.

In the example optical system 470, the detector unit 400 and the optical lens assembly 420 may be configured to detachably coupled to each other, for example by a threaded ring and barrel or other coupler. Thus, optical lens assemblies of different type may be attached to the detector unit 400. The detector unit 400 may be configured to optically cooperate to (e.g., optically interact, cooperate, or correspond with) the optical lens assembly 420 such that the infrared radiation 460 is focused onto the infrared detector 430 for capturing images of the infrared radiation 460. The infrared detector 430 is adapted to interact with a detector unit lens 440. The infrared radiation 460 passes through the optical lens assembly 420 to the detector unit 400 and is refracted again by the detector unit lens 440. The detector unit lens 440 is arranged to refract the infrared radiation 460 received from the optical lens assembly 420 towards the infrared detector 430, and may be fixed or moveable in relation to the infrared detector 430. It is to be noted that any lens comprised in any of the exemplified embodiments of the optical system may have a spherical surface, an aspherical surface, or both types of surfaces.

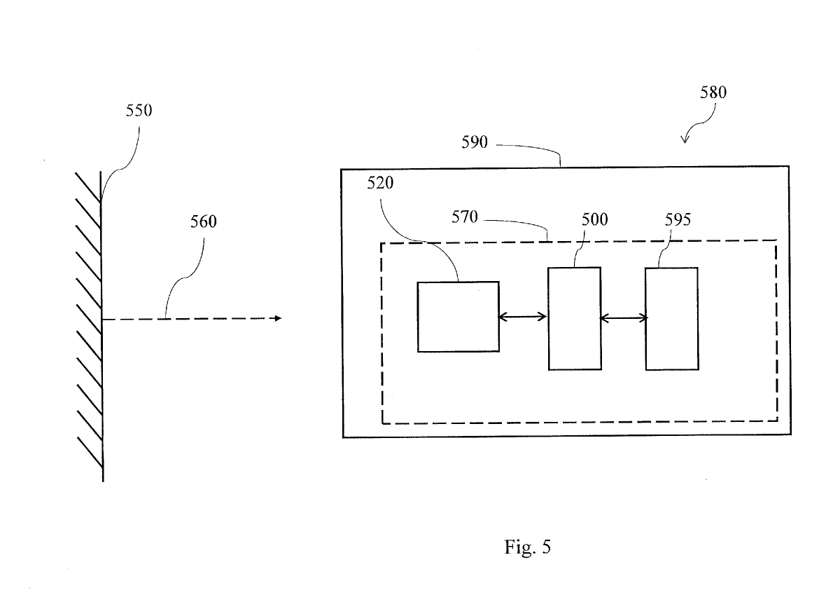

With reference to FIG. 5, a thermal camera assembly 580 for generating images based on infrared radiation 560 from an observed scene 550 will now be described, in accordance with an embodiment of the disclosure. The thermal camera assembly 580 comprises a housing 590 comprising an optical system 570 with an optical lens assembly 520 arranged to receive infrared radiation 560, and a detector unit 500. The detector unit 500 comprises a detector unit lens (not shown) arranged to refract the infrared radiation 560 received via the optical lens assembly 520, and an infrared detector (not shown) arranged to capture images (e.g., in the form IR image data, pixel data, or other analog or digital signal or data representing IR radiation intensity) of the received infrared radiation. The housing 590 at least partly encloses the detector unit 500. The detector unit 500 and the optical lens assembly 520 are configured to fit (e.g., cooperate or corresponding optically with each other) such that infrared radiation received by the optical lens assembly 520 is captured by the infrared detector 530. An IR image generation unit 595 is arranged to generate an IR image, for example, by converting and/or processing signals or data generated by the infrared detector 530 in response to receiving the infrared radiation 560.

Where applicable, embodiments herein can be implemented using hardware, software, or combinations of hardware and software. Also where applicable, the various hardware components and/or software components set forth herein can be combined into composite components comprising software, hardware, and/or both. Where applicable, the various hardware components and/or software components set forth herein can be separated into sub-components comprising software, hardware, or both. In addition, where applicable, it is contemplated that software components can be implemented as hardware components, and vice-versa. Where applicable, the ordering of various steps described herein can be changed, combined into composite steps, and/or separated into sub-steps to provide features described herein.

The foregoing disclosure is not intended to limit the present scope to the precise forms or particular fields of use. It is contemplated that various alternate embodiments and/or modifications to the present disclosure, whether explicitly described or implied herein, are possible in light of the disclosure. Accordingly, the scope of protection is defined only by the accompanying claims.

1. A detector unit for an infrared (IR) imaging device, the detector unit comprising:
a focal plane array (FPA) of IR detectors configured to detect IR radiation intensity; and
a detector unit lens configured to optically direct IR radiation onto the FPA and to protect the FPA from contamination,
wherein the detector unit lens and the FPA are integrated to form the detector unit that encapsulates the FPA, and
wherein the detector unit lens is configured to optically function as a common lens element for a plurality of different types of lens assemblies of the IR imaging device.

2. The detector unit according to claim 1, wherein said detector unit lens is configured to reduce optical aberrations for the plurality of different types of lens assemblies.

3. The detector unit according to claim 1, further comprising a baffle arranged between the FPA and the detector unit lens to reduce stray IR radiation reaching the FPA.

4. The detector unit according to claim 1, further comprising a sealing provided with the detector unit lens and/or with the FPA, the sealing being configured to seal the detector unit from an external environment to protect the FPA from contamination.

5. The detector unit according to claim 1, wherein the detector unit lens is arranged to reduce different optical effects for different fields of view.

6. The detector unit according to claim 1, wherein the detector unit lens is a germanium lens or a chalcogenide lens.

7. The detector unit according to claim 1, wherein:
the FPA is encapsulated additionally by a detector window close to the FPA than the detector unit lens; and/or
the detector unit comprises an additional detector unit lens.

8. An infrared (IR) imaging system for capturing images of external IR radiation from a scene, the IR imaging system comprising:
the detector unit of claim 1; and
a lens assembly configured to receive and pass the external IR radiation onto the detector unit lens of the detector unit.

9. The IR imaging system of claim 8, wherein said detector unit and said lens assembly are configured to optically direct and focus the external IR radiation onto the FPA to capture the images of the external IR radiation.

10. The IR imaging system of claim 8, wherein said detector unit and said lens assembly are moveable in relation to each other to focus the external IR radiation onto the FPA.

11. The IR imaging system of claim 8, wherein the optical lens assembly comprises one or more optical elements, and wherein the optical lens assembly is configured to optically cooperate with said detector unit.

12. The IR imaging system of claim 8, wherein the detector unit is configured to fit with a plurality of lens assemblies, each with different optical characteristics.

13. The IR imaging system of claim 8, wherein a field of view (FOV) of the IR imaging system is selected from 7, 20, 30, 38, 45, 55 or 60 degrees.

14. A method of manufacturing a detector unit for an infrared (IR) imaging device, the method comprising:
providing a focal plane array (FPA) of IR detectors configured to detect IR radiation intensity;
determining optical properties of a detector unit lens to optically function as a common lens element for a plurality of different types of lens assemblies of the IR imaging device; and
encapsulating the FPA by integrating the detector unit lens and the FPA to form the detector unit, such that the detector unit lens optically directs IR radiation onto the FPA and protects the FPA from contamination.

15. The method according to claim 14, wherein the determining of the optical properties comprises determining the shape of the detector unit lens that reduces optical aberrations for the plurality of different types of lens assemblies.

16. The method according to claim 14, wherein the determining of the optical properties comprises determining the shape of the detector unit lens that reduces different optical effects for different fields of view.

17. The method according to claim 14, wherein the determining of the optical properties comprises determining the distance of the detector unit lens from the FPA.

18. The method according to claim 14, further comprising providing a baffle between the detector unit lens and the FPA to reduce stray IR radiation reaching the FPA, wherein the providing of the baffle comprises determining the shape, size, and/or location of the baffle by analyzing the stray IR radiation associated with the detector unit lens and the FPA.

19. The method according to claim 14, further comprising: providing a seal with the detector unit lens and/or with the FPA to seal the detector unit from an external environment to protect the FPA from contamination.

20. The method according to claim 14, further comprising:
providing an additional detector unit lens; and/or
encapsulating the FPA additionally by a detector window close to the FPA than the detector unit lens.
